(19) United States
(12) Patent Application Publication
(10) Pub. No.: US 2017/0024752 A1
(43) Pub. Date: Jan. 26, 2017

(54) METHOD FOR FORECASTING AN INTERVAL BETWEEN INTEREST REGISTERED FOR A PARTICULAR GOOD OR SERVICE AND PURCHASE OF THE PARTICULAR GOOD OR SERVICE

(71) Applicant: MasterCard International Incorporated, Purchase, NY (US)

(72) Inventors: Amit SINGH, Indira Nagar (IN); Sanket NERKAR, Mumbai naka (IN); Mayank PRAKASH, Dehradun (IN)

(73) Assignee: MasterCard International Incorporated, Purchase, NY (US)

(21) Appl. No.: 15/217,191

(22) Filed: Jul. 22, 2016

(30) Foreign Application Priority Data
Jul. 24, 2015 (SG) 10201505781T

(51) Int. Cl. G06Q 30/02; G06Q 30/06; G06F 17/30

(52) U.S. Cl. CPC G06Q 30/0202; G06F 17/30867; G06Q 30/0623

(57) ABSTRACT

Disclosed is method that includes processing the past registered interest data against the past purchase data to identify past purchases resulting from registered past interest so as to determine a period between each of the identified past purchases and the registered past interest; deriving parameters, from one or more of the determined periods, for a prediction algorithm configured to forecast the interval between the interest registered for the particular good or service and purchase of the particular good or service; processing, using the prediction algorithm, present data of interest registered on one or more goods or services that are related to the particular good or service to calculate an estimate of the interval between the registered present interest and the purchase of the particular good or service; and planning the product related activities in response to the estimated interval. Related apparatus and a non-transitory computer readable medium are also disclosed.

### FIELD OF INVENTION

The present invention relates broadly, but not exclusively, to methods for forecasting an interval between interest registered for a particular good or service and purchase of the particular good or service.

### BACKGROUND

Forecasting is used in many fields, since they provide a tool by which parties, such as merchants, marketers and researchers, can predict changes that may occur within their respective areas of interest, to make the necessary preparations.

There are known prediction tools that seek to predict changes in sales from past purchase data. One of such tools provides a score to determine the probability of demand increasing for a particular product, so that a merchant may plan his inventory management accordingly.

There are also other known tools that seek to predict changes in consumer behaviour, such as a change of preference from one brand to another for a good or service.

The above known tools provide means to determine outcomes from past data that are directly linked to the outcome that is being predicted. For example, the prediction tool that seeks to predict whether an increase in demand for a particular product will occur uses past sales data. With forecasting still remaining an inexact science, a need therefore exists to provide further prediction tools to merchants which can further assist them with inventory management.

### SUMMARY

According to a first aspect of the present invention, there is provided a computer-implemented method for forecasting an interval between interest registered for a particular good or service and purchase of the particular good or service in order to plan product related activities, the method comprising: obtaining past purchase data of one or more goods or services that are related to the particular good or service; obtaining past data of interest registered on the related one or more goods or services; processing the past registered interest data against the past purchase data to identify past purchases resulting from registered past interest so as to determine a period between each of the identified past purchases and the registered past interest; deriving parameters, from one or more of the determined periods, for a prediction algorithm configured to forecast the interval between the interest registered for the particular good or service and purchase of the particular good or service; processing, using the prediction algorithm, present data of interest registered on one or more goods or services that are related to the particular good or service to calculate an estimate of the interval between the registered present interest and the purchase of the particular good or service; and planning the product related activities in response to the estimated interval.

According to a second aspect of the present invention, there is provided an apparatus for forecasting an interval between interest registered for a particular good or service and purchase of the particular good or service in order to plan product related activities, the apparatus comprising: at least one processor; and at least one memory including computer program code; the at least one memory and the computer program code configured to, with at least one processor, cause the apparatus at least to: process, using a prediction algorithm, present data of interest registered on one or more goods or services that are related to the particular good or service to calculate an estimate of the interval between the registered present interest and the purchase of the particular good or service, wherein the parameters of the prediction algorithm are derived from one or more periods between past purchases and registered past interest, wherein the past purchases are obtained from past purchase data of one or more goods or services that are related to the particular good or service and the registered past interest is obtained from past data of interest registered on the related one or more goods or services and wherein the one or more periods is determined by processing the past registered interest data against the past purchase data to identify the past purchases resulting from the registered past interest, wherein the at least one memory and the computer program code are further configured to, with the at least one processor, cause the apparatus to plan the product related activities in response to the estimated interval.

According to a third aspect of the present invention, there is provided a non-transitory computer readable medium having stored thereon executable instructions for controlling a computer to perform steps comprising obtaining past purchase data of one or more goods or services that are related to the particular good or service; obtaining past data of interest registered on the related one or more goods or services; processing the past registered interest data against the past purchase data to identify past purchases resulting from registered past interest so as to determine a period between each of the identified purchases and the registered interest; deriving parameters, from one or more of the determined periods, for a prediction algorithm configured to forecast the interval between the interest registered for the particular good or service and purchase of the particular good or service; processing, using the prediction algorithm, present data of interest registered on one or more goods or services that are related to the particular good or service to calculate an estimate of the interval between the registered present interest and the purchase of the particular good or service; and planning the product related activities in response to the estimated interval.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows various phases that a customer may go through when purchasing a product.

FIG. 2 shows a process, in accordance with one embodiment of the invention, for a computer-implemented method for forecasting an interval between interest registered for a particular good or service and purchase of the particular good or service in order to plan product related activities.

FIG. 3 shows a first graph which plots past data of interest registered on a good or service, extracted from a web search engine database; and a second graph which plots past purchase data extracted from an enterprise data warehouse.

FIG. 4 depicts an exemplary computing device, to realize an apparatus to implement the process shown in FIG. 2.

FIG. 5 shows various steps that are based on the process shown and described with respect to FIG. 2.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

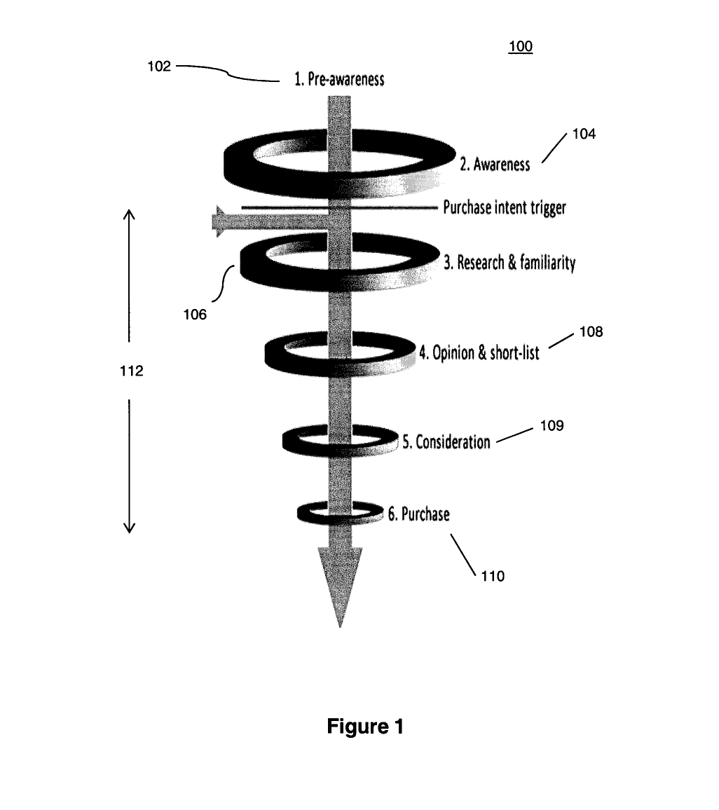

FIG. 1 shows various phases that a customer may go through when purchasing a product. This product may be a good or service.

In stage 102, the customer is unaware about the product. Once there is awareness, in stage 104, about the product and purchase intent, the customer may conduct research in stage 106 on the product before purchase. This research may be conducted within the category that the product falls under and may extend to goods or services that are related to the product. In stage 108, the customer may then form an opinion about each of the researched products so as to short-list the products for purchase. In stage 109, the customer may then make a consideration of the short-listed products and in stage 110 purchase one or more of these products.

The time lag over which stages 104 to 110 span is a period or interval 112 that ranges between minutes to months. The following discloses a method and an apparatus that serves to estimate this interval 112 between the interest registered for a particular good or service and purchase of the particular good or service.

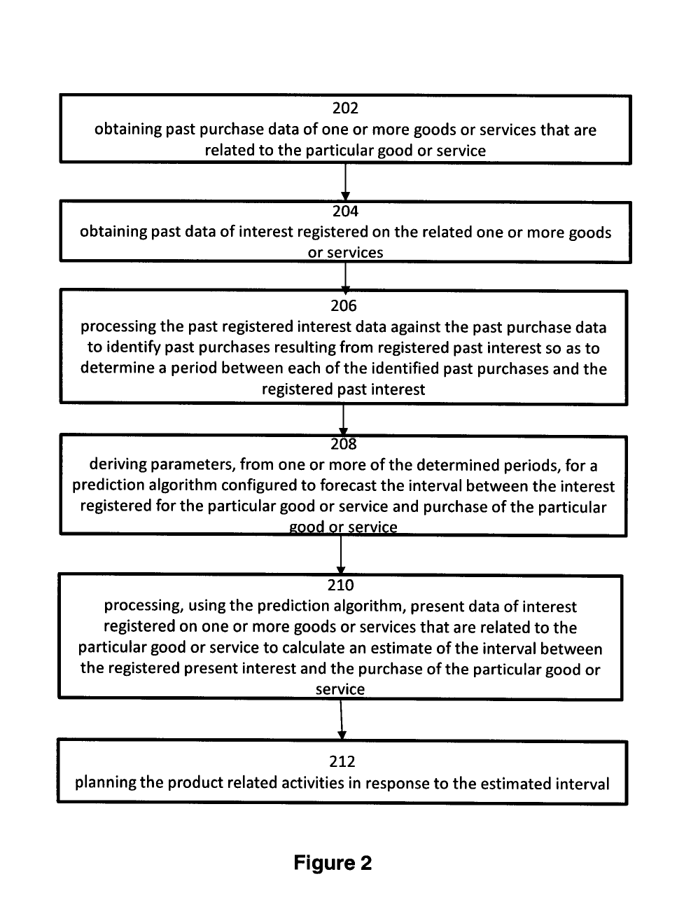

FIG. 2 shows a process, in accordance with one embodiment of the invention, for a computer-implemented method for forecasting an interval (such as the interval 112 of FIG. 1) between interest registered for a particular good or service and purchase of the particular good or service in order to plan product related activities. The method comprises the steps 202, 204, 206, 208, 210 and 212 which are explained in further detail below.

In step 202, past purchase data of one or more goods or services that are related to the particular good or service are obtained. Thus, the past purchase data may not be confined to solely the particular good or service being analysed, since there may be inter-relatedness between goods and services that fall under a same category. For instance, if the particular good or service being analysed is a car, goods or services that relate to the car may include tires, steering wheels or motor insurance. The past purchase data may be extracted from an enterprise data warehouse. The enterprise data warehouse may be populated with data comprising any one or more of credit card transactions, debit card transactions or stored-value card transactions. These credit card, debit card or stored-value card transactions may include the following types of transaction data:
Transaction level information:—
   Transaction ID
   Account ID
   Merchant ID
   Transaction Amount
   Transaction Local Currency Amount
   Date of Transaction
   Time of Transaction
   Type of Transaction
   Date of Processing
   Merchant Category Code (MCC)
Account Information (i.e. information about the account holder of the credit card, debit card or stored-value card):—
   Account ID (which may be anonymized)
   Card Group Code
   Card Product Code
   Card Product Description
   Card Issuer Country
   Card Issuer ID
   Card Issuer Name
Merchant Information:—
   Merchant ID
   Merchant Name
   MCC/Industry Code
   Industry Description
   Merchant Country
   Merchant Address
   Merchant Postal Code
   Merchant Acquirer ID (i.e. the identity of the financial institution that pays the merchant when a purchase is made)
Issuer Information (i.e. information about the financial institution that has provided or issued the credit card, debit card or stored-value card):—
   Issuer ID
   Issuer Name
   Issuer Country
      In step 202, it may be determined which of the above transaction data is extracted to compose the past purchase data, for example by analysing the type of transaction from the transaction level information.

In step 204, past data of interest registered on the related one or more goods or services are obtained. Similar to step 202, the past data of interest may not be confined to solely the particular good or service being analysed, since there may be inter-relatedness between goods and services that fall under a same category. The past data of interest registered on the related one or more goods or services may be extracted from a web search engine database. This past data of interest may be constructed from any one or more of search terms which are stored in the web search engine database, the search terms comprising any one or more of a word, a phrase or a string. For example, a web search engine database may store such search terms whenever their web search engine is utilised to perform a search, so that these stored search terms form a repository from which the past data of interest may be constructed. In step 204, the search terms may be analysed to determine whether they relate to the particular good or service to which the interval 112 (see FIG. 1) is being forecasted. The moment (i.e. time and date) at which the search terms were entered may also be analysed so as to determine whether the timing falls within a predetermined time frame to qualify as data that facilitates a more accurate estimate of the interval 112, so as to reject search terms that were entered too long ago that may lead to an inaccurate estimate.

In step 206, the past registered interest data of the step 204 (i.e. the past data of interest registered on the related one or more goods or services) is processed against the past purchase data of the step 202 to identify past purchases resulting from registered past interest so as to determine a period between each of the identified past purchases and the registered past interest. Accordingly, the process of FIG. 2 is distinguished from earlier prediction tools since the comparison of past registered interest data and past purchase data is not to predict how a change in interest registered in related goods or services will impact the change in demand for a particular good or service, but rather to predict when the impact of the change in demand for the particular good or service will occur. Since there may be more than one past purchase deemed to result from a registered past interest, there may be one or more of such periods that are determined in step 206. The processing of the past registered interest data against the past purchase data may be performed by a statistical technique. The statistical technique may be based on a model that comprises any one or more of index creation, moving averages or regression.

In step 208, the period between each of the identified past purchases and the registered past interest are used to derive a prediction algorithm configured to forecast the interval between the interest registered for the particular good or service and purchase of the particular good or service. That is, in step 208, parameters for a prediction algorithm configured to forecast the interval between the interest registered for the particular good or service and purchase of the particular good or service are derived from one or more of the determined periods. In one implementation, the prediction algorithm of the step 208 is a different algorithm from the algorithm used in the step 206 to process the past registered interest data against the past purchase data to determine a period between each of the identified past purchases and the registered past interest. That is, the algorithm used in the step 206 is a first algorithm, while the prediction algorithm of the step 208 is a second algorithm, wherein the first algorithm and the second algorithm are different.

The prediction algorithm that is derived in step 208 may then be used to forecast the interval 112 of FIG. 1. In step 210, the prediction algorithm is used to process present data of interest registered on one or more goods or services that are related to the particular good or service to calculate an estimate of the interval between the registered present interest and the purchase of the particular good or service. Similar to step 204, the present data of interest registered on the related one or more goods or services may be extracted from a web search engine database. This present data of interest may be constructed from any one or more of search terms which are stored in the web search engine database, the search terms comprising any one or more of a word, a phrase or a string. Thus, in the context of steps 204 and 210, the present data of interest registered on one or more goods or services that are related to the particular good or service is distinguished from the past data of interest registered on one or more goods or services that are related to the particular good or service as follows. The past data of the registered interest is historical data used to construct the prediction algorithm of step 208, so that the prediction algorithm can be used to predict when purchase will occur from new data of registered interest (i.e. the present data of registered interest).

In step 212, product related activities are planned in response to the estimated interval. The product related activities may include any one or more of market research, inventory management; marketing campaigns; and sales forecasting. In one implementation, the estimated interval may be provided as data to one or more systems that are used to manage such product related activities, which are configured to utilise such data for processes used during their management. The estimated interval of the time lag between ‘intent to purchase’ and ‘actual purchase’ is thus beneficial for: forecasting sales for various industries/geography; help marketers plan their marketing campaigns; inventory management; localized planning and execution; and digital advertisement display and bidding. The method shown in FIG. 2 may thus provide a revenue stream by, for example, selling of reports, which utilise this estimated interval of time lag, to market research companies; or incentivising merchants to purchase an electronic payment solution, which incorporates the provision of this estimated interval may assist with the of time lag, since the estimated interval may assist the merchant with the planning of a more targeted MFR (merchant flash report) programme.

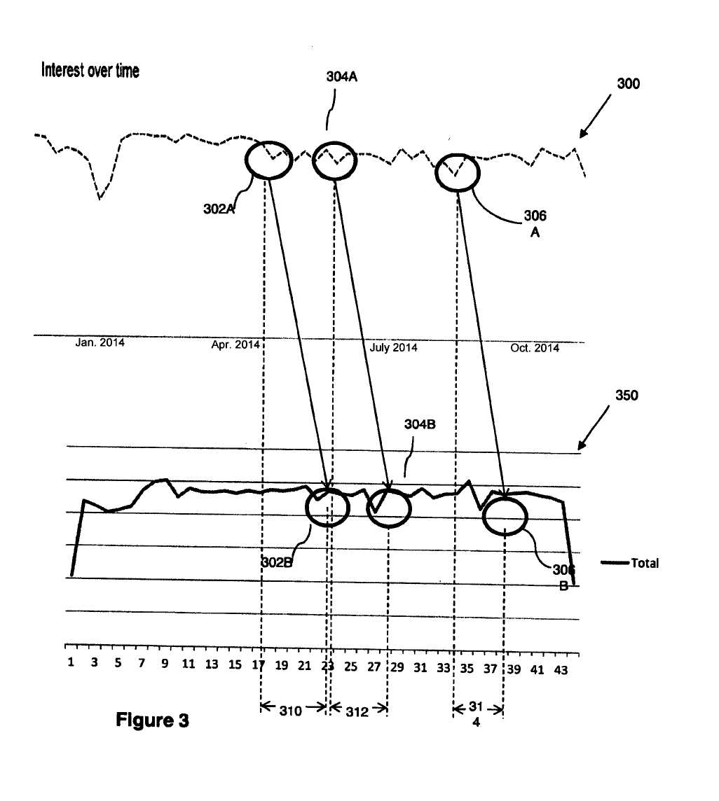

FIG. 3 shows a first graph 300 which plots past data of interest registered on a good or service, extracted from a web search engine database. In the first graph 300, past data of interest is collected between January 2014 and October 2014 from the automotive industry, with the past data of interest being extracted from Google® Trends.

FIG. 3 also shows a second graph 350 which plots past purchase data extracted from an enterprise data warehouse. In the second graph 350, the past purchase data may be sales taken from transactions within the automotive industry using MasterCard® payment cards, which include one or more of credit cards, debit cards or stored value cards.

When the past registered interest data of the first graph 300 is processed against the past purchase data of the second graph 350, such as in the step 206 of the computer-implemented method of FIG. 2, to identify past purchases resulting from registered past interest, this identification may comprise matching corresponding trends in the past registered interest data and the past purchase data. For instance, in the step 206, it may be identified that the trends 302B, 304B and 306B of the past purchase data respectively match the trends 302A, 304A and 306A. The period 310 between the matching trends 302A and 302B; the period 312 between the matching trends 304A and 304B; and the period 314 between the matching trends 306A and 306B may then be used, to derive, in the step 208 of the computer-implemented method of FIG. 2, parameters of the prediction algorithm configured to forecast the interval between the interest registered for the particular good or service and the purchase of the particular good or service.

It will be appreciated that data from the automotive industry is used as an example in the illustration of FIG. 3. Parameters for the prediction algorithm of the step 210 of the computer-implemented method of FIG. 2 are preferably constructed from past purchase data and past registered interest data of one or more goods or services that are related to the particular good or service where the interval between interest registered for the particular good or service and purchase of the particular good or service is being forecasted. For instance, the goods or services that are related to the particular good or service may comprise goods or services falling under a category under which the particular good or service belongs. For instance, if the prediction algorithm is to estimate the interval of the time lag between ‘intent to purchase’ and ‘actual purchase’ for a computer keyboard (the particular good or service), past purchase data and past registered interest data may be taken from goods or services falling under computer accessories. In addition, the parameters of the prediction algorithm derived from past purchase data of goods or services that are more closely related to the particular good or service are assigned a higher weightage compared to parameters of the prediction algorithm derived from past purchase data of goods or services that are less closely related to the particular good or service. Taking the example where the particular good or service is a computer keyboard, past purchase data and past registered interest data of a computer mouse may be assigned a higher weightage compared to past purchase data and past registered interest data of a web camera. The prediction algorithm may comprise any one or more of an artificial neural network model or a correlation based model.

An exemplary correlation based model, which uses the following equation

Sᵢ₊ₜ=Intercept+Iᵢ*Coefficient (Equation 1)

may be used as the prediction model. Equation 1 is a line of best fit obtained using, for example, a regression analysis technique. “S” represents the spend Index, a dependent variable that is based on past purchase data, which may, for example, be obtained from transaction data from an enterprise data warehouse, such as from a MasterCard® database. “Intercept” is the expected mean value of “S” when “I”=0. “I” represents an Intent Index, which may be an independent variable, that in turn represents inputs or causes that are tested to see if they are the cause. “I” may be obtained from external data, for example internet search data from a web search engine database, which can be used as a proxy for intent. In this example, “I” is obtained from the number of searches (i.e. past data of registered interest in a related good or service), in a manner similar to how “S” is obtained from past purchase data. i represents the base period, while t represents the time shift between intent and spend data: “Coefficient” represents a coefficient of determination used in statistical analysis, a number that indicates how well data fits a statistical model. It provides a measure of how well observed outcomes are replicated by the model, as the proportion of total variation of outcomes explained by the model. In one implementation, “coefficient” represents the mean change in “S” for one unit of change in “I”. In another implementation, “coefficient” is the slope of the line of best fit obtained using a regression analysis technique. For a time period, the maximum value of “S”, the spend index, is considered as 100 while “S” is computed as spend of that period divided by the maximum value of spend times 100. Equation 1 is to be solved to obtain this value of t, which provides an estimate of the interval between the registered present interest and the purchase of the particular good or service.

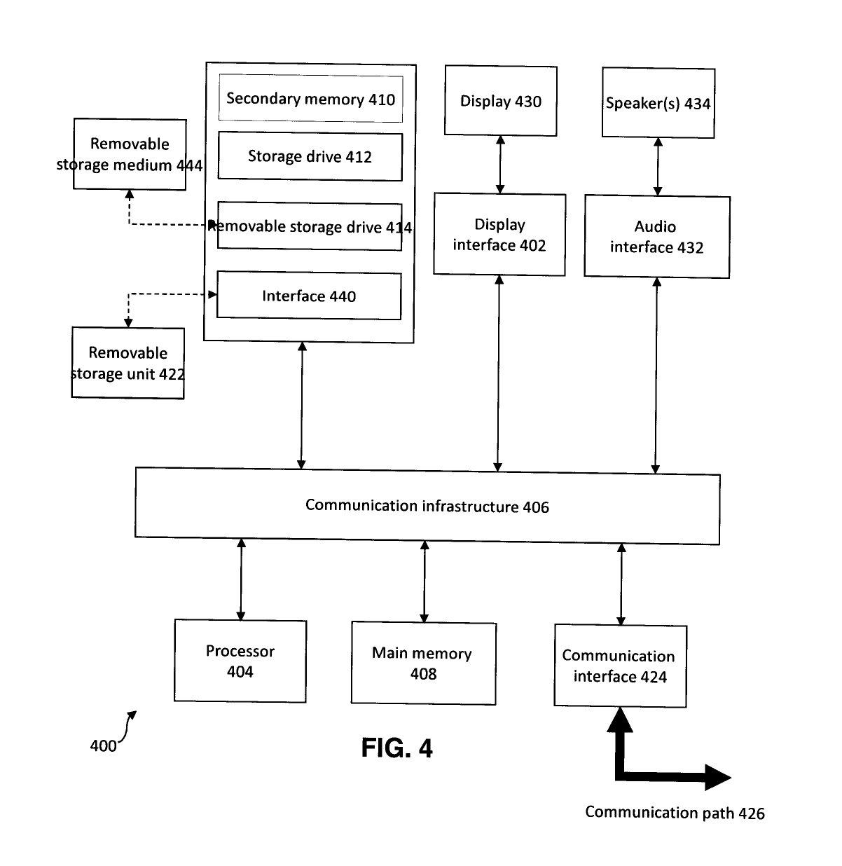

FIG. 4 depicts an exemplary computing device 400, hereinafter interchangeably referred to as a computer system 400, where one or more such computing devices 400 may be used to execute the above-described method for forecasting an interval between interest registered for a particular good or service and purchase of the particular good or service in order to plan product related activities. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a storage drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage medium 444 in a well-known manner. The removable storage medium 444 may include magnetic tape, optical disk, non-volatile memory storage medium, or the like, which is read by and written to by removable storage drive 414. As will be appreciated by persons skilled in the relevant art(s), the removable storage medium 444 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 440. Examples of a removable storage unit 422 and interface 440 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 440 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments of the inventions, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage medium 444, removable storage unit 422, a hard disk installed in storage drive 412, or a carrier wave carrying software over communication path 426 (wireless link or cable) to communication interface 424. Computer readable storage media refers to any non-transitory, non-volatile tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the storage drive 412, or the interface 440. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

It will be appreciated that the elements illustrated in FIG. 4 function to provide means for performing the computer implemented method as described with respect to FIG. 2. For example, the computing device 400 provides an apparatus for forecasting an interval between interest registered for a particular good or service and purchase of the particular good or service in order to plan product related activities, the apparatus comprising: at least one processor 404 and at least one memory 408 including computer program code.

The at least one memory 408 and the computer program code are configured to, with at least one processor 404, cause the apparatus at least to: process, using a prediction algorithm, present data of interest registered on one or more goods or services that are related to the particular good or service to calculate an estimate of the interval between the registered present interest and the purchase of the particular good or service. The parameters of the prediction algorithm are derived from one or more periods between past purchases and registered past interest. The past purchases are obtained from past purchase data of one or more goods or services that are related to the particular good or service and the registered past interest is obtained from past data of interest registered on the related one or more goods or services. The one or more periods is determined by processing the past registered interest data against the past purchase data to identify the past purchases resulting from the registered past interest.

The at least one memory 408 and the computer program code are further configured to, with the at least one processor 404, cause the apparatus to plan the product related activities in response to the estimated interval.

The computing device 400 of FIG. 4 may execute the process shown in FIG. 2 when the computing device 400 executes instructions which may be stored in any one or more of the removable storage medium 444, the removable storage unit 422 and storage drive 412. These components 422, 444 and 412 provide a non-transitory computer readable medium having stored thereon executable instructions for controlling a computer to perform steps comprising: a) obtaining past purchase data of one or more goods or services that are related to the particular good or service; b) obtaining past data of interest registered on the related one or more goods or services; c) processing the past registered interest data against the past purchase data to identify past purchases resulting from registered past interest so as to determine a period between each of the identified purchases and the registered interest; d) deriving parameters, from one or more of the determined periods, for a prediction algorithm configured to forecast the interval between the interest registered for the particular good or service and purchase of the particular good or service; e) processing, using the prediction algorithm, present data of interest registered on one or more goods or services that are related to the particular good or service to calculate an estimate of the interval between the registered present interest and the purchase of the particular good or service; and f) planning the product related activities in response to the estimated interval.

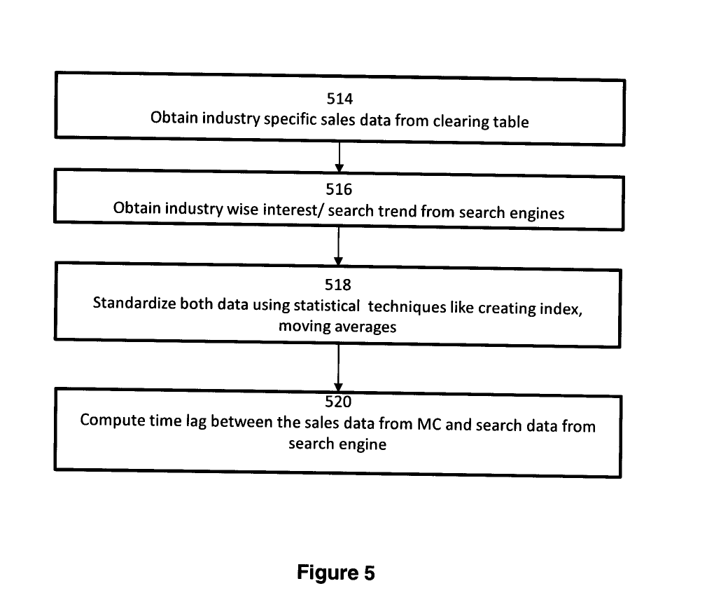

FIG. 5 shows various steps that are based on the process shown and described with respect to FIG. 2. These various steps 514, 516, 518 and 520 may also be executed by the computing device of FIG. 4 when performing the steps a) to f) as described above. The steps 514, 516, 518 and 520 are explained in further detail below.

In step 514, industry specific sales data may be obtained from a clearing table, which may be stored in an enterprise data warehouse maintained, by example, MasterCard®.

In step 516, data of industry wise registered interest or search trends registered in search engines may be obtained. Data from, for example, Google Trend® or Bing may be used.

In step 518, both data (i.e. the industry specific sales data and the data of interest that is registered in relation to such industry specific goods or services) may be standardized using statistical techniques like creating index and moving averages, so that these data can be processed against each other.

In step 520, the time lag between the sales data and the search data may be computed and used to obtain the prediction algorithm that can obtain an estimate of the time lag between a separate set of search data and purchase of goods or services that are the subject of the search data.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A computer-implemented method for forecasting an interval between interest registered for a particular good or service and purchase of the particular good or service in order to plan product related activities, the method comprising:
obtaining past purchase data of one or more goods or services that are related to the particular good or service;
obtaining past data of interest registered on the related one or more goods or services;
processing the past registered interest data against the past purchase data to identify past purchases resulting from registered past interest so as to determine a period between each of the identified past purchases and the registered past interest;
deriving parameters, from one or more of the determined periods, for a prediction algorithm configured to forecast the interval between the interest registered for the particular good or service and purchase of the particular good or service;
processing, using the prediction algorithm, present data of interest registered on one or more goods or services that are related to the particular good or service to calculate an estimate of the interval between the registered present interest and the purchase of the particular good or service; and
planning the product related activities in response to the estimated interval.

2. The method of claim 1, wherein the identification of the past purchases resulting from registered past interest comprises matching corresponding trends in the past registered interest data and the past purchase data.

3. The method of claim 1, wherein the processing of the past registered interest data against the past purchase data is performed by a statistical technique.

4. The method of claim 3, wherein the statistical technique is based on a model that comprises any one or more of index creation, moving averages or regression.

5. The method of claim 1, wherein the prediction algorithm comprises any one or more of an artificial neural network model or a correlation based model.

6. The method of claim 1, wherein the past purchase data is extracted from an enterprise data warehouse.

7. The method of claim 6, wherein the enterprise data warehouse is populated with data comprising any one or more of credit card transactions, debit card transactions or stored-value card transactions.

8. The method of claim 1, wherein the past data of interest registered on the related one or more goods or services or the present data of interest registered on one or more goods or services is extracted from a web search engine database.

9. The method of claim 8, wherein the web search engine database comprises any one or more of search terms comprising any one or more of a word, a phrase or a string.

10. The method of claim 1, wherein the goods or services that are related to the particular good or service comprises goods or services falling under a category under which the particular good or service belongs.

11. The method of claim 1, wherein the product related activities include any one or more of market research, inventory management; marketing campaigns; and sales forecasting.

12. The method of claim 1, wherein the parameters of the prediction algorithm derived from past purchase data of goods or services that are more closely related to the particular good or service are assigned a higher weightage compared to parameters of the prediction algorithm derived from past purchase data of goods or services that are less closely related to the particular good or service.

13. An apparatus for forecasting an interval between interest registered for a particular good or service and purchase of the particular good or service in order to plan product related activities, the apparatus comprising:
at least one processor; and
at least one memory including computer program code;
the at least one memory and the computer program code configured to, with at least one processor, cause the apparatus at least to:
process, using a prediction algorithm, present data of interest registered on one or more goods or services that are related to the particular good or service to calculate an estimate of the interval between the registered present interest and the purchase of the particular good or service, wherein the parameters of the prediction algorithm are derived from one or more periods between past purchases and registered past interest, wherein the past purchases are obtained from past purchase data of one or more goods or services that are related to the particular good or service and the registered past interest is obtained from past data of interest registered on the related one or more goods or services and wherein the one or more periods is determined by processing the past registered interest data against the past purchase data to identify the past purchases resulting from the registered past interest,
wherein the at least one memory and the computer program code are further configured to, with the at least one processor, cause the apparatus to
plan the product related activities in response to the estimated interval.

14. A non-transitory computer readable medium having stored thereon executable instructions for controlling a computer to perform steps comprising
obtaining past purchase data of one or more goods or services that are related to the particular good or service;
obtaining past data of interest registered on the related one or more goods or services;
processing the past registered interest data against the past purchase data to identify past purchases resulting from registered past interest so as to determine a period between each of the identified purchases and the registered interest;
deriving parameters, from one or more of the determined periods, for a prediction algorithm configured to forecast the interval between the interest registered for the particular good or service and purchase of the particular good or service;
processing, using the prediction algorithm, present data of interest registered on one or more goods or services that are related to the particular good or service to calculate an estimate of the interval between the registered present interest and the purchase of the particular good or service; and
planning the product related activities in response to the estimated interval.
